(19) United States
(12) Patent Application Publication
(10) Pub. No.: US 2013/0110340 A1
(43) Pub. Date: May 2, 2013

(54) ELECTRIC VEHICLE, CHARGING STAND, AND METHOD FOR CHARGING THE ELECTRIC VEHICLE

(71) Applicants: Sung Chul Park, Incheon (KR); Yong Hwan Yu, Incheon (KR)

(72) Inventors: Sung Chul Park, Incheon (KR); Yong Hwan Yu, Incheon (KR)

(73) Assignee: V-Ens Co. Ltd, Incheon (KR)

(21) Appl. No.: 13/809,116

(22) PCT Filed: Jul. 8, 2011
(86) PCT No.: PCT/KR2011/005037

§ 371 Date: Jan. 8, 2013

(30) Foreign Application Priority Data
Jul. 9, 2010 (KR) 1020100066338
Aug. 2, 2010 (KR) 1020100074744

(51) Int. Cl. B60L 11/18; H02J 7/00

(52) U.S. Cl. CPC B60L 11/1838; H02J 7/0052
USPC 701/22; 320/109

(57) ABSTRACT

The present invention relates to a system for charging an electric vehicle and to a method for charging the electric vehicle. A charging stand which supplies electric power for charging to the electric vehicle performs user authentication or vehicle authentication for the electric vehicle to be charged, so as to prevent unauthorized charging or theft and thus enable the electric vehicle to be stably charged. In addition, a connection circuit is used as a connection cable or a connector for charging, which interconnects the vehicle and a charging side by means of a single line to enable both the vehicle and the charging side to recognize the interconnection, thus simplifying the configuration of the circuit for enabling the vehicle and the charging side to recognize the interconnection, and enabling both the vehicle and the charging side to easily recognize whether or not they are interconnected.

### TECHNICAL FIELD

The present invention relates to an electric vehicle, a charging stand, and a method for charging the electric vehicle, and more particularly to an electric vehicle capable of being charged for a long time under a stable charging environment, a charging stand, and a method for charging the electric vehicle.

### BACKGROUND ART

Electric vehicles (EVs) have been actively studied because they are the most promising alternative capable of solving pollution and energy problems in the future.

Electric vehicles (EVs) are mainly powered by driving an AC or DC motor using battery power. Electric vehicles are broadly classified into battery powered electric vehicles and hybrid electric vehicles. In the battery powered electric vehicles, a motor is driven using power of a battery, and the battery is recharged after the stored power is completely consumed. In hybrid electric vehicles, a battery is charged with electricity generated via engine driving, and an electric motor is driven using the electricity to realize vehicle movement.

Hybrid electric vehicles may further be classified into serial electric vehicles and parallel electric vehicles. In the case of serial hybrid electric vehicles, mechanical energy output from an engine is changed into electric energy via a generator, and the electric energy is fed to a battery or motor. Thus, the serial hybrid electric vehicles are always driven by a motor similar to conventional electric vehicles, but an engine and generator are added for the purpose of increasing range. Parallel hybrid electric vehicles may be driven using two power sources, i.e. a battery and an engine (gasoline or diesel). Also, the parallel hybrid electric vehicles may be driven using both the engine and the motor according to traveling conditions.

With recent development of motor/control technologies, small high-output and high-efficiency systems have been developed. By replacing a DC motor with an AC motor, electric vehicles have accomplished considerably enhanced output and power performance (acceleration and maximum speed) comparable to gasoline vehicles. As a result of promoting a higher output and higher revolutions per minute, a motor has achieved reduction in weight and size, and consequently reduction in the weight and size of a vehicle provided with the motor.

A battery of the electric vehicle is charged with power and the vehicle starts driving using the battery power, such that it is necessary to stably supply the current charged in the battery to the vehicle as soon as the vehicle starts driving.

In the case of a charging station for charging the electric vehicle, a charging cable mounted to the vehicle is connected to the vehicle and a charging stand, such that the electric vehicle starts to be charged. Alternatively, assuming that an accounting system for charging a fee through RF card authentication is included in the electric vehicle, once RF card authentication is normally completed, the electric vehicle starts charging.

However, the conventional system for charging the electric vehicle has disadvantages in that a user must carry a charging cable and the cable may be unexpectedly stolen.

It takes a long time to charge the electric vehicle. If the cable is detached during vehicle charging and is connected to a different vehicle, the different vehicle is charged with power and the user is charged a charging fee.

If a cable or connector is connected to the electric vehicle at a charging station or the like, not only a line via which data or a charging current flows but also a line via which the electric vehicle is normally connected to the cable or connector is needed. Specifically, two lines are needed to detect whether the electric vehicle is connected to the charging station.

However, if two lines for sensing connection between the electric vehicle and the charging station are used, this means that the two lines are used for the same function corresponding to connection recognition, resulting in unnecessary double installation of line.

Assuming that connection between the electric vehicle and the charging station is recognized using only one line, such connection is recognized by one side whereas the connection is not recognized by the other side, such that it is difficult for the electric vehicle and the charging station to simultaneously recognize such connection.

If the connection is recognized by both sides through only one line, a communication IC needs to be used. Therefore, a circuit configured to recognize connection between both sides must include high-priced components, resulting in increased production costs.

In conclusion, there is a need for a method allowing both sides to recognize connection of a coupling connector via only one line, and implementing a charging system with a simple circuit.

### DISCLOSURE

### Technical Problem

Therefore, the present invention has been made in view of the above problems, and an object of the present invention is to provide an electric vehicle, a charging stand, and a method for charging the electric vehicle. In more detail, when the electric vehicle is charged, illegal access to the system is prevented through user authentication and vehicle authentication, such that the electric vehicle can be more conveniently charged under a more stable environment.

Another object of the present invention is to provide an electric vehicle for simplifying a connection circuit of connectors when a cable or connector is connected to the electric vehicle, such that mutual connection between the electric vehicle and the cable or connector can be easily recognized.

### Technical Solution

In accordance with one aspect of the present invention, the above and other objects can be accomplished by an electric vehicle comprising: a battery management system (BMS) for managing a state of a battery pack in response to charging of the pack or the operating power supplied from the battery pack; a charging unit for charging the battery pack using a charging current supplied through a connector; a vehicle communication unit for communicating with a charging stand through a communication terminal included in the connector; and a vehicle control module (VCM), upon receiving a request from the charging stand during vehicle charging, for transmitting vehicle information including not only unique vehicle information but also a battery-pack charging state received from the battery management system (BMS) to the charging stand through the vehicle communication unit.

In accordance with another aspect of the present invention, a charging stand includes a charging plug connected to a connector of the electric vehicle so as to provide a charged power to the electric vehicle; a connection sensing unit for sensing a connection state of the charging plug, and inputting a connection sense signal or a connection release signal; a communication unit for communicating with the electric vehicle through a communication terminal contained in the charging plug, if the charging plug is connected to the electric vehicle; and a charging controller for preparing for charging of the electric vehicle in response to the connection sense signal from the connection sensing unit, performing vehicle authentication of the electric vehicle upon receiving vehicle information of the electric vehicle from the electric vehicle through the communication unit, and supplying power to the charging plug.

In accordance with another aspect of the present invention, a method for charging an electric vehicle using a charging stand includes: if a charging plug is connected to the electric vehicle, receiving vehicle information from the electric vehicle; on the basis of the vehicle information, determining whether the electric vehicle is in a chargeable state, and performing vehicle authentication of the electric vehicle; and if the electric vehicle is in the chargeable state and vehicle authentication is completed, charging the electric vehicle by supplying power to the charging plug.

### Advantageous Effects

The electric vehicle, a charging stand, and a method for charging the electric vehicle according to the embodiments of the present invention have the following effects. The electric vehicle is configured to use a charging cable fixed at a charging station, it is impossible for the electric vehicle to be stolen and a user need not carry the charging cable, resulting in greater convenience of use.

The electric vehicle according to the present invention performs user authentication and vehicle authentication. In case of charging a current electric vehicle, although the cable is detached from the current vehicle and then connected to a different vehicle, the different vehicle does not start charging, such that fraudulent vehicle charging caused by illegal access is prevented, so that a user of the current vehicle has only to pay proper charges corresponding to the amount of charged power. As a result, the electric vehicle can be conveniently charged under a more stable charging environment.

In addition, the electric vehicle according to the embodiment includes a connection circuit via which the vehicle and the charging station can be interconnected via one line, such that connection between the vehicle and the charging station can be recognized by each of the vehicle and the charging station. As a result, a circuit required for connection recognition by both sides can be simplified, circuit complexity is reduced, and production costs are also reduced. In addition, both sides can easily recognize connection or non-connection therebetween, and an additional confirmation procedure for checking connection or non-connection is no longer required, such that the electric vehicle can be easily charged.

### DESCRIPTION OF DRAWINGS

FIG. 1 is a diagram illustrating a method for charging an electric vehicle according to an embodiment of the present invention.

FIG. 2 is a perspective view illustrating a charging stand according to an embodiment of the present invention.

FIG. 3 is a block diagram illustrating an electric vehicle according to an embodiment of the present invention.

FIG. 4 is a block diagram illustrating control components of a charging stand for use in a system for charging the electric vehicle according to an embodiment of the present invention.

FIG. 5 is a circuit diagram illustrating a connector of the electric vehicle according to an embodiment of the present invention.

FIG. 6 is a circuit diagram illustrating a connector of the electric vehicle according to another embodiment of the present invention.

FIG. 7 is a flowchart illustrating a method for charging the electric vehicle using a charging stand of the charging system of the electric vehicle according to an embodiment of the present invention.

FIG. 8 is a flowchart illustrating a method for operating the charging stand during vehicle charging according to an embodiment of the present invention.

FIG. 9 is a flowchart illustrating a method for operating the electric vehicle in the charging system of the electric vehicle according to an embodiment of the present invention.

### BEST MODE

Hereinafter, an electric vehicle, a charging stand, and a method for charging the electric vehicle according to the exemplary embodiments of the present invention will be described with reference to the accompanying drawings.

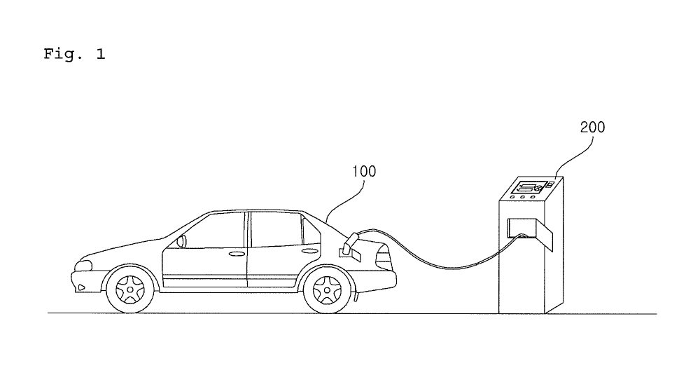

FIG. 1 is a diagram illustrating a method for charging an electric vehicle according to an embodiment of the present invention.

Referring to FIG. 1, the electric vehicle 100 includes a battery, and charges the battery upon receiving power from a charging station, vehicle charging installation, a home or an external part.

The electric vehicle is charged at a charging station or the like, starts by rotating a motor using the charged energy such that it moves by acceleration or deceleration of the motor according to a driver request.

The battery of the electric vehicle 100 has a limited capacity, power charged in the battery is gradually consumed as the vehicle is operated. If the remaining power of the battery is equal to or less than a predetermined amount of power, the electric vehicle 100 needs to be charged.

In this case, if the electric vehicle 100 is charged at a charging stand 200, the electric vehicle 100 and the charging stand 200 are interconnected through a predetermined cable and connector, mutual connection therebetween is confirmed by each of the electric vehicle 100 and the charging stand 200, and user authentication and vehicle authentication are performed. If such authentication is completed, battery charging is started.

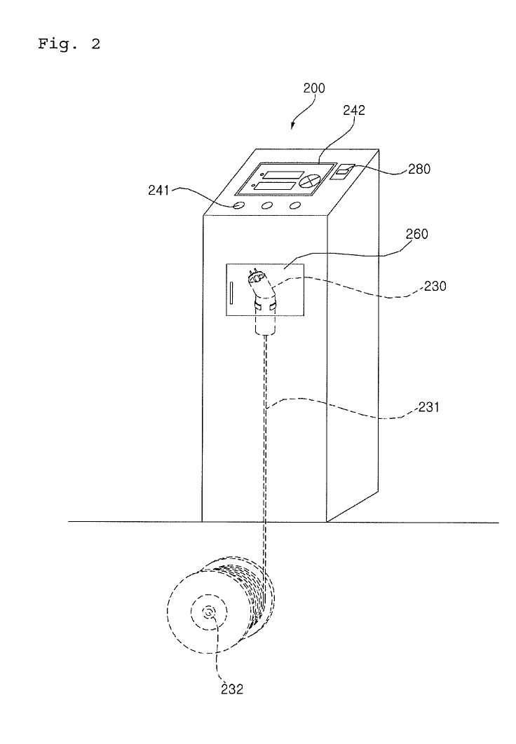

FIG. 2 is a perspective view illustrating a charging stand according to an embodiment of the present invention.

Referring to FIG. 2, the charging stand 200 includes a charging plug 230, an output unit 242, an input unit 241, a radio frequency (RF) recognition unit 280, a charging cable 231, a charging cable depository 232, and a door 260.

The charging plug 230 is installed inside the charging stand 200, and is connected to a power source through the charging cable 231.

In this case, a depository 232 including charging cables is located underground below the charging stand 200. If the charging plug 230 is taken off the charging stand 200 and connected to the vehicle, the charging cable 231 becomes unfastened. Although the electric vehicle is located distant from the charging stand 200, the charging plug can reach the vehicle.

In addition, if the charging plug 230 is inserted into the charging stand 200, the charging cable 231 is automatically rolled into the depository 232. The charging cable 231 is connected to a power-supply unit, and is also fixed to the depository 232.

The door 260 is installed into the charging stand 200. If the charging plug 230 is taken out or inserted into the charging stand 200, the door 260 is opened. If the charging plug 230 is installed inside the charging stand 200, the door 260 is closed. In addition, if the charging plug 230 is taken out and connected to the vehicle, the door 260 is closed.

In this case, the door 260 is opened or closed according to the user authentication result of the RF recognition unit 280. In addition, if the charging plug 230 is inserted into the vehicle, the door 260 may be closed or opened according to the vehicle authentication result.

The charging stand 200 allows a user to select a charging menu through an input unit 241, such that a menu screen image and a charging state are displayed on the output unit 242. If the output unit 242 is implemented as a touchscreen, a user may input desired data through the touchscreen.

In this case, the charging menu may include a charging mode in response to a selected fee, a charging mode in response to the remaining battery lifespan, a fast charging mode, etc.

If the charging menu is selected by selection of the input unit 241, user authentication is carried out through the RF recognition unit 280.

If the RF card contacts or is placed on the RF recognition unit 280, the RF recognition unit 280 reads data from the RF card and performs user authentication.

Once the user is authenticated, the door 260 is opened and the charging plug 230 is taken out and connected to the vehicle.

If the charging plug 230 is connected to the vehicle, the charging stand 200 communicates with the vehicle through the charging plug 230, and performs vehicle authentication.

If user authentication and vehicle authentication are completed, power is supplied to the charging plug 230 through the charging cable 231, so that the vehicle can be charged.

If the predetermined charging is completed or if a user inputs a command through the input unit 241, the charging stand 200 stops charging, calculates a fee generated by such charging, and displays the calculated fee through the output unit 242. In a payment process of the fee, the door 260 is opened and the charging plug 230 returns to the charging stand 200.

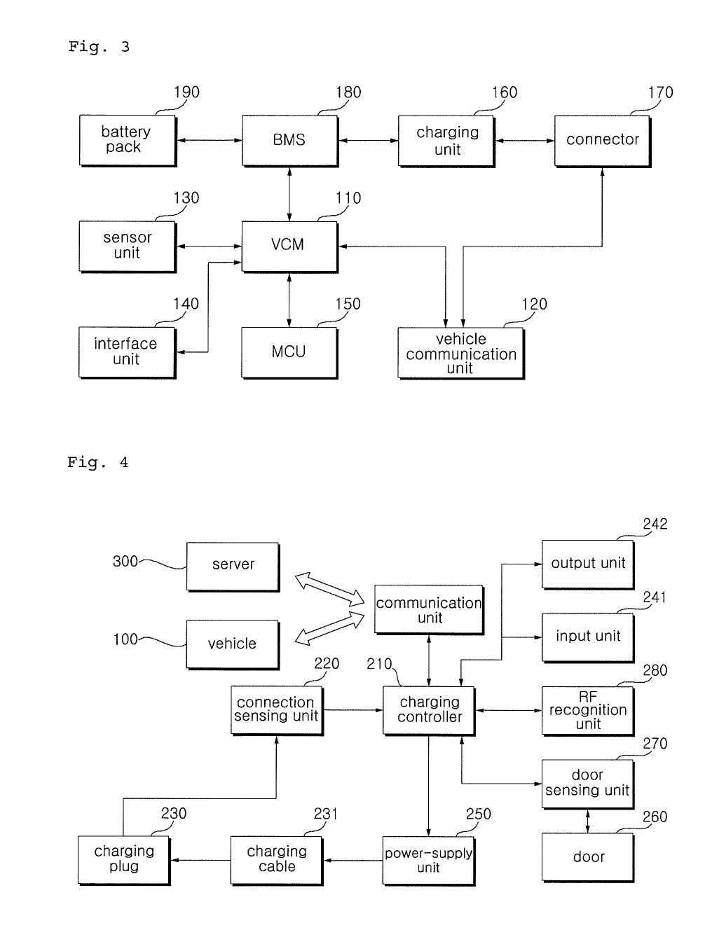

FIG. 3 is a block diagram illustrating an electric vehicle according to an embodiment of the present invention.

Referring to FIG. 3, the electric vehicle 100 includes a sensor unit 130, an interface unit 140, a motor control unit (MCU) 150, a charging unit 160, a connector 170, a vehicle communication unit 120, a battery management system 180, a battery pack 190, and a vehicle control module (VCM) 110 configured to control vehicle traveling and overall operations of the vehicle.

The electric vehicle configured to use the charged power as operating power includes a battery pack 190 including at least one battery, and charges the battery upon receiving power from a charging station, a vehicle charging installation, a home or an external part.

The electric vehicle further includes a battery management system (BMS) 180. The BMS 180 determines the remaining charge of the battery and the presence or absence of charging necessity, and performs a management operation for providing the charging current stored in the battery to each part of the electric vehicle.

When charging and using the battery, the BMS 180 maintains a regular voltage difference between cells of the battery, and controls the battery not to be overcharged or overdischarged, resulting in increased battery lifespan.

The BMS 120 performs management of the use of the current so as to perform long-time traveling of the vehicle, and includes a protection circuit for supplied current.

The battery pack 190 includes a plurality of high-voltage batteries.

If the charging plug 230 of the charging stand 200 is connected to the connector 170, the charging unit 160 charges the battery pack 190 upon receiving power supplied through the connector 170 from the charging plug 230.

In this case, the charging unit 160 outputs the charging current to the battery 190 under the control of the BMS 180, so that the battery can be charged.

The connector 170 includes not only a power-supply terminal but also a communication terminal. If the connector 170 is connected to the charging plug 230, it enables the vehicle to receive power from the charging stand 200, and at the same time the charging stand can communicate with the vehicle communication unit 120.

If the connector 170 is connected to the charging plug 230, the vehicle communication unit 120 communicates with the charging stand 200 through a communication terminal mounted to the connector 170.

The vehicle communication unit 120 outputs information regarding the remaining battery lifetime or the battery charge capacity of the vehicle to the charging stand 200, and transmits unique information of the vehicle in response to a request from the charging stand 200. The vehicle communication unit 120 performs CAN communication of the charging stand 200.

The sensor unit 130 detects signals generated when the vehicle runs or performs a predetermined operation, and inputs the detected signals to the vehicle control module (VCM).

The sensor unit 130 includes a plurality of sensors inside or outside of the vehicle so that it can detect a variety of signals. In this case, different types of sensors may be used according to installation positions.

The interface unit 140 includes an input unit to input predetermined signals via operation of a driver, an output unit to output information on the current operating state of the electric vehicle, and a manipulation unit for allowing a vehicle driver to input a command for vehicle control.

The output unit includes a display for displaying information; a speaker for outputting music, sound effects, and warning sounds; and various state indicator lamps, etc. The input unit includes a plurality of switches and a plurality of buttons to operate a turn signal, a tail lamp, a head lamp, brushes, etc. The interface unit 140 includes manipulators such as a steering wheel, an accelerator, a brake, etc.

The MCU 150 generates a control signal for driving at least one motor connected thereto, generates a predetermined signal for motor control, and applies the generated signal to the motor. In addition, the high-voltage power is changed according to motor characteristics, such that the changed power is supplied to the electric vehicle.

The vehicle control module (VCM) 110 generates, applies, and controls a predetermined command in such a manner that an operation corresponding to input signals of the interface unit 140 and the sensor unit 130 can be carried out. Therefore, the vehicle control module (VCM) 110 controls data I/O operations so that it displays an operation state of the household appliances.

In addition, the vehicle control module (VCM) 110 manages the battery pack 190 through the BMS 180, performs startup control of the vehicle, and controls power supply to a specific position (component).

If the connector 170 is connected to the charging plug 230, the vehicle control module (VCM) 110 receives information regarding the connection state, such that the vehicle is charged through the charging unit 160 and data communication between the vehicle control module (VCM) 110 and the charging stand 200 is controlled through the vehicle communication unit 120.

Specifically, upon receiving unique information of the vehicle from the charging stand 200, the vehicle control module (VCM) 110 transmits the stored unique information of the vehicle to the vehicle communication unit 120 so that the unique information is transmitted to the charging stand 200.

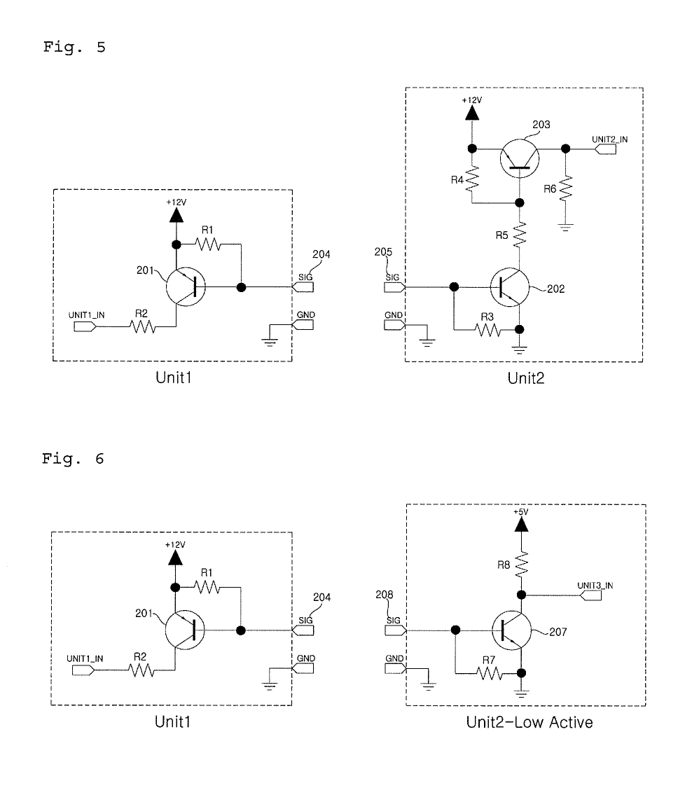

FIG. 4 is a block diagram illustrating control components of the charging stand for use in the system for charging the electric vehicle according to an embodiment of the present invention.

Referring to FIG. 4, the charging stand 200 includes a charging plug 230, a charging cable 231, a power-supply unit 250, a connection sensing unit 220, a communication unit 290, a radio frequency (RF) recognition unit 280, an output unit 242, an input unit 241, a door sensing unit 270, a door 260, and a changing control unit 210 configured to control overall operations of the charging stand.

As can be seen from FIG. 2, the charging stand 200 includes the charging plug 230 therein, and the charging plug 230 is taken out and connected to the vehicle according to the opening or closing of the door 260, so as to charge the vehicle.

The charging plug 230 is connected to the connector 170, receives power from the power-supply unit 250 through the charging cable 231, transmits the received power to the vehicle, and is connected to a communication terminal of the connector 170.

If the communication unit 290 is connected to the vehicle through the charging plug 230, it communicates with the vehicle communication unit 190.

The communication unit 290 may transmit or receive data from/to the vehicle communication unit 120 in response to a control command, and outputs data received from the vehicle communication unit 120 to the charging controller 210.

In this case, the communication unit 290 includes a plurality of communication modules, such that it communicates with the vehicle and the external server. Upon receiving a control command from the charging controller 210, the communication unit 290 transmits unique vehicle information received from the vehicle communication unit 120 to the external server 300, and requests vehicle authentication.

The connection sensing unit 220 determines if the charging plug 230 is connected to the connector 170, and inputs a connection sensing signal to the charging controller 210. If the connector 170 is disconnected from the charging plug 230, the connection sensing unit 220 inputs a connection release signal to the charging controller 210.

The output unit 242 includes a predetermined display and a speaker, informs a user of a charging menu, outputs a charging state, and outputs accounting information when the vehicle stops charging. In addition, the output unit may output information messages regarding the charging method.

The input unit 241 includes at least one button or touch input unit, so that a user can select and input the charging menu (menus are lists of menu items, to execute a function a menu item is selected) using the button or touch input unit.

The RF recognition unit 280 recognizes the RF card, and performs user authentication upon receiving user information from the RF card. In this case, the RF recognition unit 280 performs self-authentication according to information of the RF card, and transmits an authentication request to the external server 300 through the communication unit 290.

If the vehicle stops charging, the RF recognition unit 280 allows the user to pay a usage fee using the RF card.

If the charging menu is selected by the input unit 241 and user authentication is completed by the RF recognition unit 280, the charging controller 210 controls the door 260 to be open.

In this case, the door sensing unit 270 detects the opened door, and informs the charging controller 210 of the opened door state.

If the door 260 is open, the user can take the charging plug 230 out of the charging stand. If the charging plug 230 is connected to the connector 170 of the vehicle, the connection sensing unit 220 outputs a signal indicating connection to the vehicle to the charging controller 210.

If the charging plug 230 is connected to the vehicle, the charging controller 210 is connected to the vehicle communication unit 120 through a communication terminal mounted to the charging plug and vehicle charging information and unique information are requested through the communication unit 290 and then received in the charging controller 210.

The charging controller 210 determines whether charging is possible in response to the received vehicle charging information, transmits unique vehicle information to an external server through the communication unit 290, and requests the server to perform vehicle authentication.

If the door 260 is closed, vehicle authentication is completed, and the vehicle is rechargeable, the charging controller 210 provides the vehicle with power from the power-supply unit 250.

The charging controller 210 stops charging in response to data input via the input unit 241 or the RF recognition unit 280, calculates the charging fees, and allows the user to pay the fees through the RF recognition unit 280.

If the charging plug 230 is connected to the vehicle before charging or after opening of the door 260, the charging controller 210 controls the door 260 to be closed. Once charging is completed, the charging controller 210 re-opens the door 260 such that the charging plug 230 returns to the charging stand 200 through the door 260. After the charging plug 230 returns to the charging stand 200, the charging controller 210 controls the door 260 to be closed. In this case, although the door 260 is opened only under the control of the charging controller 210, assuming that the door 260 is open, the user can manually close the door 260 as necessary.

FIG. 5 is a circuit diagram illustrating a connector of the electric vehicle according to an embodiment of the present invention.

Referring to FIG. 5, when the electric vehicle is charged, the connector 170 of the electric vehicle interconnects the charging unit 160 and an external charging station (i.e., a charging stand). In this case, the connector 170 includes a connection terminal electrically connected to a charging terminal of the charging stand, and a connection circuit for recognizing such interconnection.

The connector 170 provides the power supplied through the connection terminal to the charging unit 160 so as to perform battery charging. Before the power is supplied to the charging unit 160, it is determined whether the electric vehicle is normally connected to the charging station through the connection terminal.

The connector 170 determines whether the electric vehicle is normally connected to the charging station through any one of a plurality of lines of the connection terminal. In this case, the charging station also determines whether the charging terminal is normally connected to the connection terminal of the electric vehicle through only one line and supplies power to the electric vehicle. In this case, the connection circuit is used to check whether the electric vehicle is normally connected to the charging station.

Referring to FIG. 5, the connection circuit of the connector 170 of the electric vehicle is comprised of a plurality of resistors and transistors. Here, the connection circuit of the connector is mounted to each of the charging unit and the other unit for providing a charging current. The connection circuit may be mounted to each of the electric vehicle and the charging station.

A connection circuit of a first unit (Unit 1) includes a first transistor 201 and resistors (R1, R2) connected to respective terminals of the first transistor 201.

In this case, the first transistor 201 is a pnp transistor that is turned on upon circuit connection.

A collector of the first transistor 201 is connected to the second resistor R2, and is connected to an internal circuit. The emitter is connected to a reference voltage (12V), a base is connected to a connection terminal 204, and the emitter and the base are interconnected through the first resistor R1.

A second unit (Unit 2) includes a second transistor 202, a third transistor 203, and resistors R3 to R6 connected thereto. The second transistor 202 is an npn transistor, and the third transistor is a pnp transistor.

In the second transistor 202, a base is connected to the connection terminal 205, a base and an emitter are connected to the third resistor R3, the emitter is grounded, and a collector is connected to the base of the third transistor 203 through the fifth resistor R5.

In the third transistor 203, a base and an emitter are connected to a fourth resistor R4, an emitter is connected to a reference voltage of 12V, and a collector is connected to an internal circuit. In this case, a sixth resistor R2 is connected in parallel to the collector.

In addition, each of the second transistor 202 and the third transistor 203 includes a line for a ground terminal.

Since the connection circuit is configured as described above, if the units are interconnected, i.e., if a connection terminal of the electric vehicle is connected to a connection terminal of the charging station, the first to third transistors are operated so that interconnection can be detected.

In this case, before the connection terminals 204 and 205 of both sides are interconnected, the first transistor 201 serving as a pnp transistor is connected to a reference voltage and the base through the first resistor R1, and a logic high signal is input to the base of the first transistor 201, such that the first transistor 201 outputs a logic high signal (0V).

Since the logic low signal is input to the second transistor 202 through the third resistor R3, the second transistor 202 does not operate and a logic high signal is input to a base of the third transistor 203 because of the fourth resistor R4, such that a logic low signal (0V) is output.

If connection terminals 204 and 205 of both sides are interconnected, the first resistor R1 and the third resistor R3 are connected in series such that voltage division is achieved. In this case, the magnitude of the divided voltage is changed according to resistances of the first resistor R1 and the third resistor R3. Therefore, resistance values of the first resistor R1 and the third are adjusted such that voltages applied to respective transistors can be adjusted.

Through adjustment of resistances of the first resistor R1 and the third resistor R3, a logic low signal is input to a base of the first transistor 201, and a logic high signal is input to a base of the second transistor 202.

For example, if the first resistor R1 and the third resistor R3 have the same resistance, a voltage of 6V is applied to each transistor, and a reference voltage of 12V is connected to an emitter of the first transistor 201, so that 6V is recognized as a logic low signal. The emitter of the second transistor 202 is grounded and kept at 0V, so that the second transistor 202 recognizes a voltage of 6V as a logic high signal.

If a signal is input to the bases of the first and second transistors 201 and 202, each transistor is turned on. In this case, a voltage of 12V is output to the collector of the first transistor 201, and is then applied to an internal circuit, this means a connection state of the connection terminals.

In addition, if the second transistor 202 is turned on, it is connected to the reference voltage 12V through the fourth resistor R4 and the fifth resistor R5. Thus a voltage applied to the base of the third transistor 203 is changed according to the resistance ratio of the fourth resistor R4 and the fifth resistor R5.

If the fourth resistor R4 has the same resistance as the fifth resistor R5, a voltage of 6V is applied to the fourth resistor R4 so that 6V is applied to the base of the third transistor 203. Since a reference voltage of 12V is connected to the emitter of the third transistor 203, 6V applied to the base is recognized as a logic low signal, so that the third transistor 203 is also turned on.

Accordingly, a voltage of 12V is output to the collector of the third transistor 203, and is also applied to an internal circuit, this means connection of the connection terminals.

In this case, Unit 1 and Unit 2 may be set to the electric vehicle and the charging station, respectively. If the electric vehicle is set to Unit 1, the charging station may be used as Unit 2. If the electric vehicle is set to Unit 2, the charging station may be used as Unit 1.

In a circuit configured to use a reference voltage of 5V, the resistance value is adjusted in a manner that 2V or 3V is applied to the pnp transistor, so that the pnp transistor may recognize the signal of 2V or 3V as a logic low signal.

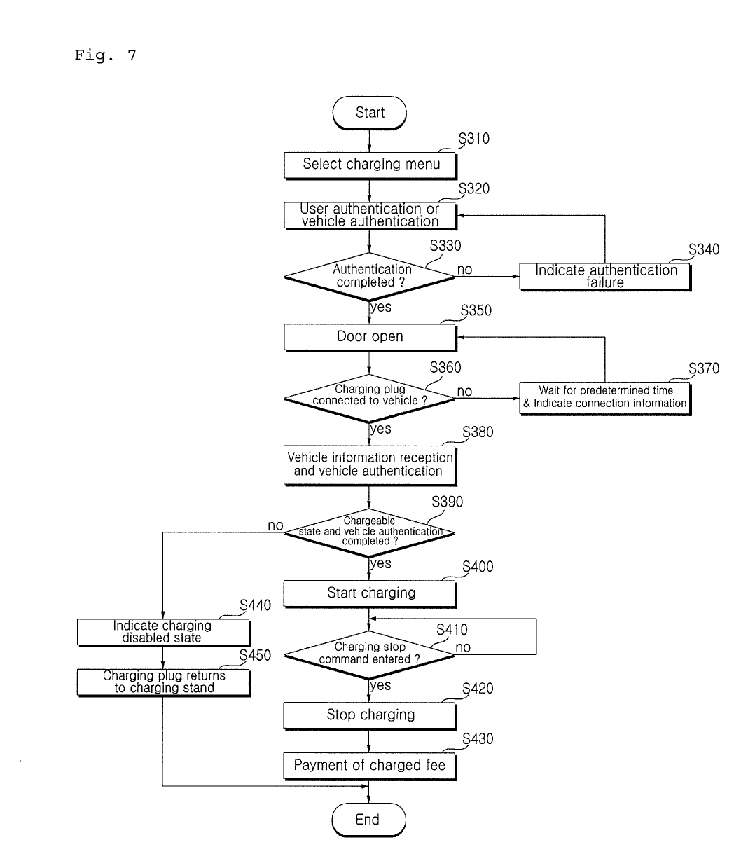

FIG. 6 is a circuit diagram illustrating a connector of the electric vehicle according to another embodiment of the present invention. Referring to FIG. 6, Unit 1 is configured as shown in FIG. 5, and Unit 2 is configured as follows. A connection circuit of Unit 2 shown in FIG. 6 is a low active circuit.

The connection circuit of the Unit 2 is comprised of a fourth transistor 207 and resistors (R7, R8).

A base of the fourth transistor 207 is connected to the connection terminal 208, the base and the emitter of the fourth transistor 207 are connected to the seventh resistor R7, and the emitter is grounded. In addition, the collector of the fourth transistor 207 is connected to a second reference voltage 5V through the eighth resistor R8, and the fourth transistor 207 is connected to an internal circuit through the collector.

Unit 1 is driven as described above. If Unit 1 is connected to Unit 2 through connection terminals (204, 208), the first transistor 201 and the fourth transistor 207 are operated due to voltage division between the first resistor R1 and the seventh resistor R7.

Therefore, Unit 1 outputs a voltage of 12V to the collector of the first transistor 201, and outputs the signal of 12V to the internal circuit, so that it can recognize connection of the connection terminals.

In Unit 2, under the condition that the fourth transistor 207 is not turned on, a second reference voltage of 5V is applied to the internal circuit connected to the collector of the fourth transistor 207, so that a voltage of 5V is input to the internal circuit.

In this case, if Unit 1 and Unit 2 are connected to connection terminals 204 and 208, a voltage is applied to the seventh resistor R7, such that a voltage is applied to the base of the fourth transistor 207 and the fourth transistor 207 is operated. In this case, if the fourth transistor 207 is turned on, 0V is applied to the internal circuit. Unit 2 is operated in the low active scheme. The voltage applied to the internal circuit is reduced from 5V to 0V, such that the internal circuit detects connection of the connection terminals.

Unit 1 and Unit 2 (i.e., the electric vehicle and the charging station) are connected to a first line of the connection terminals, a connection circuit is configured in each of Unit 1 and Unit 2, such that connection of the connection terminals can be easily detected by each of Unit 1 and Unit 2 using a simple connection circuit, and resistance values are adjusted in a manner that Unit 1 and Unit 2 are recognized in different ways. As a result, the above-mentioned connection circuit can be used as a connection circuit for use in various circuits.

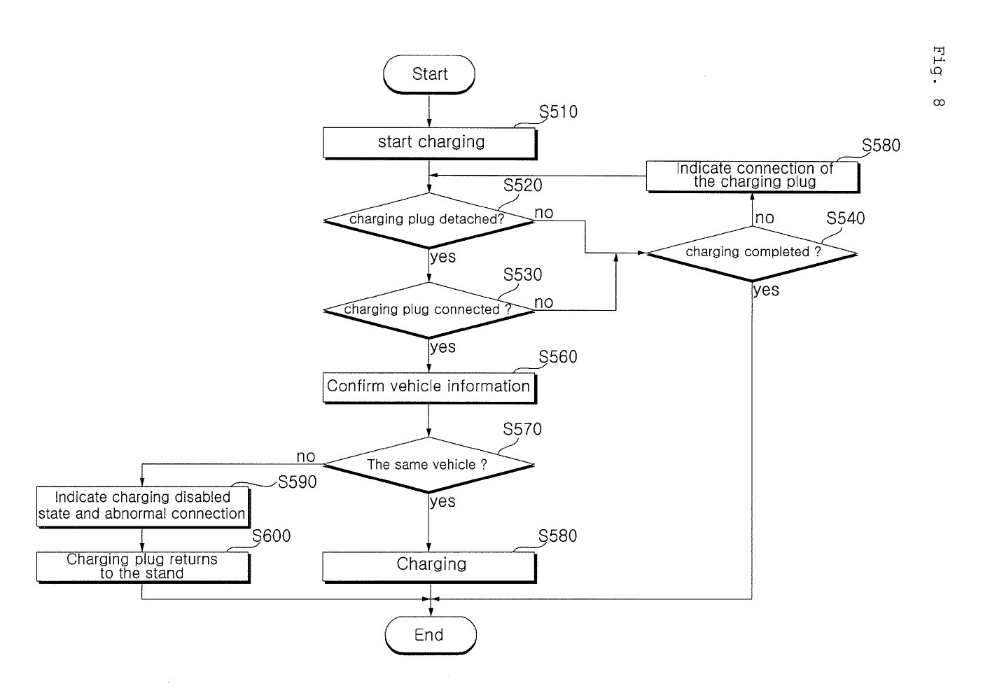

FIG. 7 is a flowchart illustrating a method for charging the electric vehicle using a charging stand of the charging system of the electric vehicle according to an embodiment of the present invention.

Referring to FIG. 7, any one of the charging menus displayed on the output unit 242 of the charging stand 200 is selected through the input unit 241 in step S310.

The RF recognition unit 280 receives RF card information by recognizing the RF card, and performs user authentication using the RF card in step S320. For this purpose, the RF card may be in contact with the RF recognition unit 280 or may be located within a predetermined distance of the RF recognition unit 280. The RF recognition unit 280 may be self-authenticated, or may request an external server to perform authentication through the communication unit 290.

In this case, a text message requesting that the RF card be brought into contact with the RF recognition unit 280 is displayed on the output unit 242, or a voice message may be output through the output unit 242, and other text messages or voice messages related to the subsequent processes may also be output through the output unit 242.

If a user authentication failure occurs, the charging controller 210 allows an information message indicating authentication failure to be displayed on the output unit 242 in step S340, and re-performs user authentication through the RF recognition unit 280 in steps S320 and S330.

The charging controller 210 determines whether the RF recognition unit 280 finishes user authentication in step S330. If user authentication is completed, the charging controller 210 opens the door 260 such that the charging plug 230 can be taken out in step S350.

After the door 260 is opened, if the charging plug 230 is connected to the connector 170 of the vehicle, the connection sensing unit 220 detects this connection state and informs the charging controller 210 of the detected result.

The charging controller 210 determines whether the charging plug 230 is connected to the vehicle according to the received connection sensing signal in step S360.

If the connection sensing signal is not input to the charging controller 210 after the door has been opened, the charging controller 210 waits for a predetermined time and commands the output unit 242 to display a message indicating that the charging plug 230 is connected to the vehicle.

If the charging plug 230 is normally connected to the vehicle connector 170, it is connected to the vehicle communication unit 120 through the communication terminal of the charging plug 230, such that the charging controller 210 can communicate with the vehicle through the communication unit 290 in step S380.

In this case, the communication unit 290 receives a vehicle charging state and unique vehicle information from the vehicle, and inputs the received information to the charging controller 210.

Upon receiving the vehicle charging state and the unique vehicle information from the communication unit 290, the charging controller 210 transmits unique information of the vehicle to the external server 300 and requests that the server 30 perform vehicle authentication in step S380.

The charging controller 210 determines whether the vehicle can be charged on the basis of the received charged state, and at the same time determines whether vehicle authentication is completed in step S390.

If the vehicle can be charged and vehicle authentication is completed, the charging controller 210 provides the power from the power-supply unit 250 to the charging plug 230 through the charging cable 231, such that the vehicle starts to be charged in step S400.

In this case, the charging controller 210 determines whether the door 260 is opened through the door sensing unit 270. If the door 260 is closed, the charging operation starts. If the door is opened, the charging controller 210 controls the door to be closed, or outputs an information message in such a manner that the user can manually close the door.

The supplied power is transferred to the vehicle connector 170 through the charging plug 230, and the battery pack 190 of the vehicle is charged by the vehicle charging unit 160.

If the charging operation corresponding to the selected charging menu is completed, or if the charging stop command is input through the input unit 241 or the RF recognition unit 280 in step S410, the charging controller 210 controls the power-supply unit 250 and the vehicle stops charging in step S420.

If the stop button is input through the input unit 241 or if the RF card contacts with the RF recognition unit 280, this means that the charging stop command has been input.

The charging controller 210 calculates the charging fees, allows the user to pay the charging fees through the RF recognition unit 280, and opens the door 260, such that the charging plug 230 returns to the charging stand 200.

On the other hand, if the vehicle is incapable of being charged or if vehicle authentication failure occurs in step S390, the charging controller 210 outputs a charging disabled state through the output unit 242 in step S440, and opens the door 260 such that the charging plug 230 returns to the charging stand in step S450.

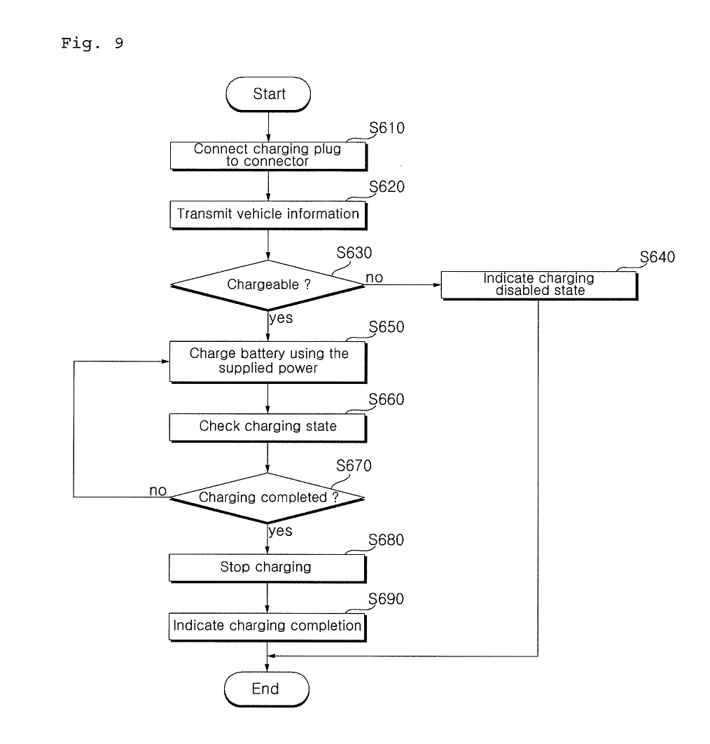

FIG. 8 is a flowchart illustrating a method for operating the charging stand during vehicle charging according to an embodiment of the present invention.

Referring to FIG. 8, the charging stand starts charging if the charging condition of FIG. 7 is satisfied in step S510.

If detachment of the charging plug 230 is detected through the connection sensing unit 220 during the charging process in step S520, the charging controller 210 controls the power-supply unit 250 to stop charging.

In addition, the charging controller 210 determines whether the detached charging plug 230 is reconnected in step S530.

In this case, if the charging plug 230 is connected to the vehicle, the connection sensing unit outputs the connection sensing signal to the charging controller 210, and the charging plug 230 determines whether the charging plug is connected through the connection sensing signal.

If the charging plug 230 is reconnected, the charging controller 210 again requests vehicle information through the communication unit 290, and receives the requested vehicle information in step S560.

Upon receiving the vehicle information from the vehicle, the charging controller 210 determines whether the current connected vehicle is identical to the first connected vehicle in step S570.

Since the charging controller 210 receives unique vehicle information when communicating with the vehicle, it compares unique vehicle information received from the reconnected vehicle with unique information of the first connected vehicle, and determines whether the reconnected vehicle is identical to the first connected vehicle according to the comparison result.

If it is determined that the reconnected vehicle is identical to the first connected vehicle, the charging controller 210 restarts vehicle charging by controlling the power-supply unit 250 in step S580.

On the other hand, if the reconnected vehicle after detachment of the charging plug 230 is different from the first connected vehicle, the charging controller 210 outputs a text or voice message indicating a charging disabled state and abnormal connection through the output unit 242.

If necessary, the output unit 242 may output a warning sound.

The charging controller 210 opens the door 260 in such a manner that the charging plug returns to the charging stand in step S600.

FIG. 9 is a flowchart illustrating a method for operating the electric vehicle in the charging system of the electric vehicle according to an embodiment of the present invention.

Referring to FIG. 9, if the charging plug 230 of the charging stand 200 is connected to the connector 170 in step S610, the vehicle control module (VCM) 110 outputs vehicle information including unique vehicle information and charging state information to the charging stand 200 through the vehicle communication unit 120 in step S620.

The VCM 110 receives charging state information of the battery pack 190 through the BMS 180, reads prestored unique vehicle information, and outputs the read information to the vehicle communication unit 120.

In this case, the vehicle communication unit 120 transmits vehicle information to the charging stand 200 through the communication terminal of the connector 170.

The VCM 110 determines whether the vehicle can be charged on the basis of charge state information of the BMS 180 in step S630. If it is impossible to charge the electric vehicle, the VCM 110 transmits a signal indicating a charging disabled state to the charging stand 200 through the vehicle communication unit 120 in step S640.

In this case, the charging stand 200 stops charging in response to a signal from the vehicle communication unit 120, such that the charging plug 230 returns to the charging stand 200.

The charging stand 200 informs a user of a charging disabled state in step S440, and the charging plug returns to the charging stand 200 in step S450.

If the vehicle can be charged, the VCM 110 controls the charging unit 160 to start charging. The charging unit 160 charges the battery pack 190 using power supplied through the connector 170 in step S650.

The BMS 180 checks a charging state of the battery pack 190, inputs the checked information to the VCM 110, and prevents the occurrence of overcharging in step S660.

If battery charging is completed in step S670, the charging unit 160 stops battery charging in step S680.

The VCM 110 outputs a charge completion state through the interface unit 140, and transmits the charge ended state to the charging stand in step S690.

In this case, although the charging operation by the selected charging menu (for example, fixed-rate charging) is not completed, the charging stand 200 stops charging upon receiving the charging completion message from the vehicle 100. Thereafter, the operations of the charging completion state are performed as shown in FIG. 7.

As is apparent from the above description, the charging plug and the charging cable are fixed to the charging stand and are protected by the door, thereby preventing the occurrence of crimes or burglaries. In addition, through user authentication and vehicle authentication, the present invention can prevent the occurrence of fraudulent vehicle charging by abnormal connection during the charging.

Therefore, a correct fee corresponding to the amount of charged power is assessed to the user, such that the user can safely utilize the vehicle charging service without fear of robbery.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An electric vehicle comprising:
a battery management system (BMS) for managing a state of a battery pack in response to charging of the pack or operating power supplied from the battery pack;
a charging unit for charging the battery pack using a charging current supplied through a connector;
a vehicle communication unit for communicating with a charging stand through a communication terminal included in the connector; and
a vehicle control module (VCM) for, upon receiving a request from the charging stand during vehicle charging, transmitting vehicle information including not only unique vehicle information but also a battery-pack charging state received from the battery management system (BMS) to the charging stand through the vehicle communication unit.

2. The electric vehicle according to claim 1, wherein the vehicle control module (VCM) transmits the unique vehicle information including not only a model name of a vehicle but also a VIN code assigned to the vehicle, to the charging stand.

3. The electric vehicle according to claim 1, wherein:
the connector is connected to the charging stand or an external power source and outputs a charging current to the charging unit, and is electrically connected to a connection circuit included in the charging stand or the external power source on the condition that the connector is connected to the charging stand or the external power source so that the connection circuit outputs a sense signal; and
the vehicle control module (VCM) controls the charging unit to start charging in response to the sense signal from the connector.

4. The electric vehicle according to claim 1, wherein:
the connector includes a connection terminal electrically contacting a charging plug of the charging stand; and
if the connection terminal is connected to the charging stand, the connection circuit is electrically connected to a connection circuit of the charging stand through any one of lines of the connection terminal.

5. The electric vehicle according to claim 4, wherein the connector, if the connection circuit is electrically connected to the connection circuit of the charging stand, outputs a predetermined voltage, and outputs the voltage serving as the sense signal to the controller.

6. The electric vehicle according to claim 4, wherein the connector, if the connection circuit comprised of at least one transistor and a plurality of resistors is connected to the external power source so that the transistor is turned on, outputs the sense signal of a predetermined value.

7. The electric vehicle according to claim 6, wherein the connector transmits a voltage divided by a ratio of resistances of the plurality of resistors to the transistor, such that the transistor is turned on.

8. The electric vehicle according to claim 6, wherein, in case of the connector, a base of a first transistor is connected to the connection terminal, an emitter thereof is connected to a reference voltage and connected to the base of a first resistor; and if the first transistor is turned on, the reference voltage is output as the sense signal through a second resistor connected to the collector.

9. The electric vehicle according to claim 6, wherein the connector includes a second transistor and a third transistor having different characteristics,
wherein a base of the second transistor is connected to the connection terminal, a grounded emitter is connected to the base through a third resistor, and a collector is connected to a base of the third transistor through a fifth resistor, and
the base of the third transistor is connected to an emitter connected to a reference voltage through a fourth resistor,
whereby if the second and third transistors are turned on, the reference voltage is output as the sense signal through a collector of the third transistor.

10. The electric vehicle according to claim 9, wherein:
if the connector is connected to the charging stand, a voltage applied through the connection terminal is voltage-divided by the third resistor so that the second transistor is turned on, and
if the second transistor is turned on, the reference voltage is voltage-divided by the fourth resistor and the fifth resistor, and the third transistor is turned on by a voltage applied to the fourth resistor.

11. The electric vehicle according to claim 6, wherein, in case of the connector, a base of the fourth transistor is connected to the connection terminal, a grounded emitter and the base are interconnected through a seventh resistor, and a collector is connected to a second reference voltage through the eighth resistor,
whereby the fourth transistor is turned on if the connection terminal is connected to the external power source, and the second reference voltage applied to an internal circuit is changed from 5V to 0V so that the changed reference voltage is recognized as the sense signal.

12. A charging stand comprising:
a charging plug connected to a connector of the electric vehicle so as to provide a charged power to the electric vehicle;
a connection sensing unit for sensing a connection state of the charging plug, and inputting a connection sense signal or a connection release signal;
a communication unit for communicating with the electric vehicle through a communication terminal contained in the charging plug, if the charging plug is connected to the electric vehicle; and
a charging controller for preparing for charging of the electric vehicle in response to the connection sense signal from the connection sensing unit, performing vehicle authentication of the electric vehicle upon receiving vehicle information of the electric vehicle from the electric vehicle through the communication unit, and supplying power to the charging plug.

13. The charging stand according to claim 12, wherein the charging controller performs vehicle authentication of the electric vehicle on the basis of unique vehicle information contained in the vehicle information, determines whether the electric vehicle can be charged in response to a charging state included in the vehicle information, and starts charging of the electric vehicle according to the determination result.

14. The charging stand according to claim 12, further comprising:
a radio frequency (RF) recognition unit for recognizing an RF card and performing user authentication and payment of a charged fee; and
a door via which the charging plug contained in the charging stand is taken out, according to whether the door is opened or closed,
wherein the charging controller, if user authentication is completed through the RF recognition unit, controls the door to be opened so that the charging plug can be taken out of the charging stand.

15. The charging stand according to claim 14, wherein, if vehicle authentication is completed, the electric vehicle is in a chargeable state, and the door is closed, the charging controller stops charging of the electric vehicle.

16. The charging stand according to claim 12, wherein the charging controller, while the electric vehicle is charged with power in response to a connection release signal from the connection sensing unit, detects that the charging plug is detached from the electric vehicle, thereby stopping charging.

17. The charging stand according to claim 16, wherein:
after the charging plug is detached from the electric vehicle, if the charging plug is then connected to a second electric vehicle, the charging controller confirms reconnection of the charging plug through the connection sensing unit, and receives vehicle information from the second electric vehicle, such that vehicle authentication of the second electric vehicle is performed.

18. The charging stand according to claim 17, wherein the charging controller compares vehicle information of the second electric vehicle with vehicle information of the electric vehicle initially connected to the charging stand, and determines that the second electric vehicle is identical to the electric vehicle if the vehicle information of the second electric vehicle is identical to the vehicle information of the initially connected electric vehicle, such that it continuously performs vehicle charging; and
if there is a difference in vehicle information, the charging controller outputs a charging disabled state and a warning message.

19. A method for charging an electric vehicle using a charging stand comprising:
if a charging plug is connected to the electric vehicle, receiving vehicle information from the electric vehicle;
on the basis of the vehicle information, determining whether the electric vehicle is in a chargeable state, and performing vehicle authentication of the electric vehicle; and
if the electric vehicle is in the chargeable state and vehicle authentication is completed, charging the electric vehicle by supplying power to the charging plug.

20. The method according to claim 19, further comprising:
before connection of the electric vehicle, selecting a charging menu, and performing user authentication; and
if the user authentication is successful, opening a door in which the charging plug is inserted.

21. The method according to claim 19, further comprising:
if the electric vehicle is in the chargeable state, vehicle authentication is completed, and the door is closed, starting charging of the electric vehicle.

22. The method according to claim 19, further comprising:
if the charging plug is detached from the electric vehicle during vehicle charging, stopping charging of the electric vehicle; and
after detaching the charging plug from the electric vehicle, if the charging plug is connected to the second electric vehicle, receiving vehicle information from the second electric vehicle and performing vehicle authentication of the second electric vehicle.

23. The method according to claim 22, further comprising:
if vehicle information of the second electric vehicle is identical to vehicle information of the initially connected electric vehicle, determining that the second electric vehicle is identical to the initially connected electric vehicle, and restarting charging of the electric vehicle; and
if there is a difference in vehicle information between the second electric vehicle and the initially connected electric vehicle, determining that the second electric vehicle is different from the initially connected electric vehicle, and outputting a warning message.

24. The method according to claim 20, further comprising:
if vehicle charging is completed or if a charging stop command is input, cutting off power supplied to the charging plug, stopping charging of the vehicle, opening the door, and allowing the charging plug to return to the charging stand.
